(19) United States
(12) Patent Application Publication
(10) Pub. No.: US 2023/0268937 A1
(43) Pub. Date: Aug. 24, 2023

(54) TRANSMITTER CIRCUIT, RECEIVER CIRCUIT, AND COMMUNICATION CIRCUIT

(71) Applicant: FUJI ELECTRIC CO., LTD., Kawasaki-shi (JP)

(72) Inventor: Keiichi ITOU, Matsumoto-city (JP)

(73) Assignee: FUJI ELECTRIC CO., LTD., Kawasaki-shi (JP)

(21) Appl. No.: 18/087,908

(22) Filed: Dec. 23, 2022

(30) Foreign Application Priority Data
Feb. 21, 2022 (JP) 2022-025064

(51) Int. Cl. H04B 1/00

(52) U.S. Cl. CPC H04B 1/0007; H04B 1/0075

(57) ABSTRACT

A transmitter circuit coupled to a receiver circuit through wiring. The transmitter circuit transmits, as an input signal, either a first signal of a rectangular waveform having a logic level that changes according to first data, or a second signal having a slope that changes corresponding to second data. The receiver circuit includes an analog-to-digital (AD) converter receiving the input signal through the wiring, and a processing circuit configured to process an output of the AD converter, to thereby determine whether the input signal is the first signal or the second signal, and upon determining that the input signal is the first signal or a second signal, acquire the first data or the second data based on the logic level of the first signal or the slope of the second signal, as the case may be.

### CROSS-REFERENCE TO RELATED APPLICATION

The present application claims priority pursuant to 35 U.S.C. §119 from Japanese patent application number 2022-025064 filed on Feb. 21, 2022, the entire disclosure of which is hereby incorporated by reference herein.

### BACKGROUND

### Technical Field

The present disclosure relates to a transmitter circuit, a receiver circuit, and a communication circuit.

### Description of the Related Art

In transmitting and receiving data between a transmitter circuit and a receiver circuit, the data to be transmitted and received may be encrypted by using common data (so-called key) (see, for example, Japanese Patent Application Publication No. 2020-36170).

In the case where the data to be transmitted and received is encrypted, in general, processing executed by the transmitter circuit and the receiver circuit is complicated.

### SUMMARY

A first aspect of an embodiment of the present disclosure is a transmitter circuit coupled to a receiver circuit through wiring, the receiver circuit including an analog-to-digital (AD) converter configured to receive an input signal through the wiring, and a processing circuit configured to process an output of the AD converter, the transmitter circuit comprising: a circuit configured to transmit to the AD converter of the receiver circuit, as the input signal, either a first signal of a rectangular waveform having a logic level that changes according to first data, or a second signal of a waveform having a slope that changes corresponding to second data, such that the processing circuit processes the output of the AD converter to thereby determine whether the input signal is the first signal or the second signal, when it is determined that the input signal is the first signal, acquires the first data, based on the logic level of the first signal, and when it is determined that the input signal is the second signal, acquires the second data, based on the slope of the second signal.

A second aspect of an embodiment of the present disclosure is a receiver circuit coupled, through wiring, to a transmitter circuit, the transmitter circuit being configured to transmit, as an input signal, either a first signal of a rectangular waveform having a logic level that changes according to first data, or a second signal of a waveform having a slope that changes corresponding to second data, the receiver circuit comprising: an analog-to-digital (AD) converter configured to receive the input signal through the wiring; and a processing circuit configured to process an output of the AD converter to thereby determine whether the input signal is the first signal or the second signal, when it is determined that the input signal is the first signal, acquire the first data, based on the logic level of the first signal, and when it is determined that the input signal is the second signal, acquire the second data, based on the slope of the second signal.

A third aspect of an embodiment of the present disclosure is a communication circuit, comprising: a transmitter circuit; and a receiver circuit coupled to the transmitter circuit through wiring, wherein the transmitter circuit is configured to transmit to the receiver circuit through the wiring, as an input signal, either a first signal of a rectangular waveform having a logic level that changes according to first data, and a second signal of a waveform having a slope that changes corresponding to second data, the receiver circuit includes an analog-to-digital (AD) converter configured to receive the input signal through the wiring, and a processing circuit configured to process an output of the AD converter to thereby determine whether the input signal is the first signal or the second signal, when it is determined that the input signal is the first signal, acquire the first data, based on the logic level of the first signal, and when it is determined that the input signal is the second signal, acquire the second data, based on the slope of the second signal.

### BRIEF DESCRIPTION OF THE DRAWINGS

FIG. 1 is a diagram illustrating an example of a communication circuit 10.

FIG. 2 is a diagram illustrating an example of a signal S1.

FIG. 3 is a diagram illustrating an example of a signal S2.

FIG. 4 is a flowchart illustrating an example of processing executed by a communication circuit 10.

FIG. 5 is a diagram illustrating an example of data transmitted and received in a communication circuit 10.

FIG. 6 is a diagram illustrating an example of a microcomputer 20 and an adjustment circuit 25.

### DETAILED DESCRIPTION

At least following matters will become apparent from the descriptions of the present specification and the accompanying drawings.

### Embodiments

### Communication Circuit 10

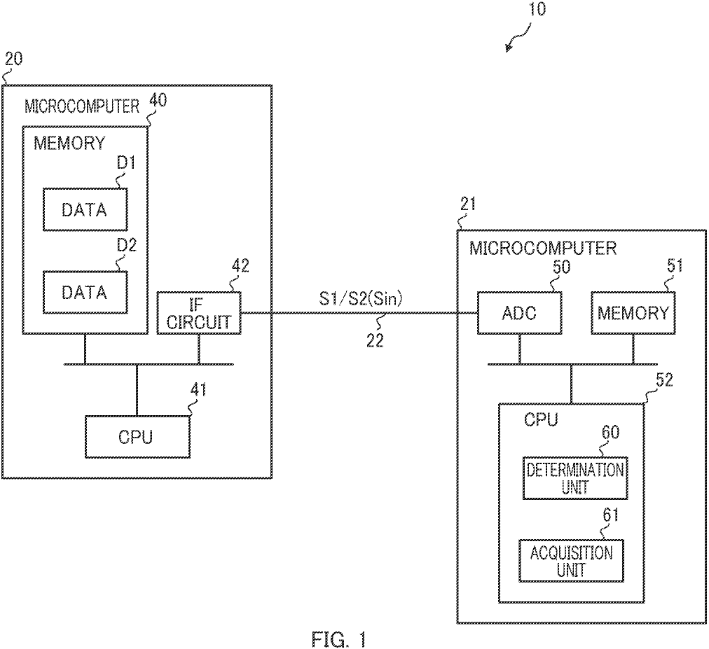

FIG. 1 is a diagram illustrating an example of a communication circuit 10 according to an embodiment of the present disclosure. The communication circuit 10 includes a microcomputer 20 that transmits data and a microcomputer 21 that receives the data from the microcomputer 20.

### Microcomputer 20

The microcomputer 20 is a “transmitter circuit” that transmits signal S1, S2 corresponding to data D1, D2 stored in a memory 40 (described later) and includes the memory 40, a central processing unit (CPU) 41, and an interface (IF) circuit 42.

The memory 40 is a circuit, such as a random access memory (RAM), a read only memory (ROM), or the like, to store various data and/or a program (not illustrated) to be executed by the CPU 41. The memory 40 of an embodiment of the present disclosure stores the data D1 and D2 to be transmitted to the microcomputer 21. Note that the data D1 and D2 are data to set the state of a predetermined circuit and/or device (not illustrated) controlled by the microcomputer 21, for example.

The CPU 41 is a processor that executes the program stored in the memory 40, to thereby control over the entirety of the microcomputer 20. The CPU 41 generates the signals S1 and S2 corresponding to the data D1 and D2, according to a predetermined protocol, which will be described later in detail.

The IF circuit 42 outputs the signal S1, S2 generated by the CPU 41 to the microcomputer 21. The IF circuit 42 of an embodiment of the present disclosure has a large driving capability sufficient to output the signal S1, S2 of a desired waveform while considering a parasitic capacitance and the like of wiring 22.

### Signal S1

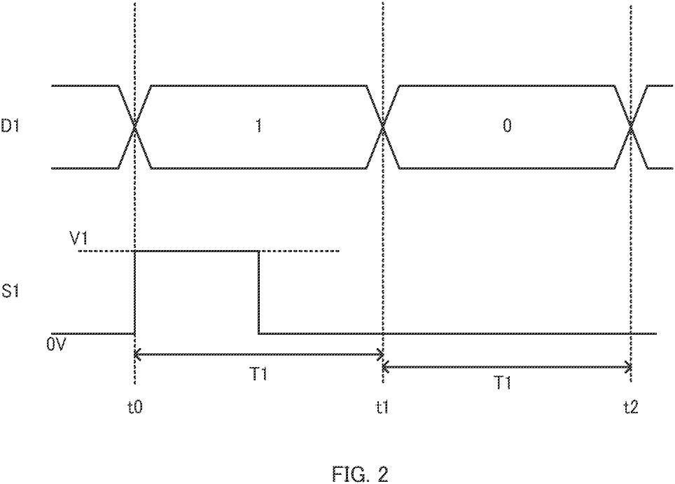

FIG. 2 is a diagram for explaining the signal S1 corresponding to the data D1 indicating “0” or “1”. When the data D1 indicates “1”, the CPU 41 changes the signal S1 into a rectangular waveform as indicated from time t0 to time t1. Specifically, the CPU 41 changes the signal S1 to a high level (hereinafter, referred to as high or high level) and then changes the signal S1 to a low level (hereinafter, referred to as low or low level).

On the other hand, when the data D1 indicates “0”, the CPU 41 outputs the low signal S1 as indicated from time t1 to time t2. It is assumed, in an embodiment of the present disclosure, that the high level is a level of a predetermined voltage V1 (for example, 3 V). In addition, a time period of the signal S1 corresponding to the minimum unit of the information included in the data D1 (in this case, 1 bit) is a time period T1.

### Signal S2

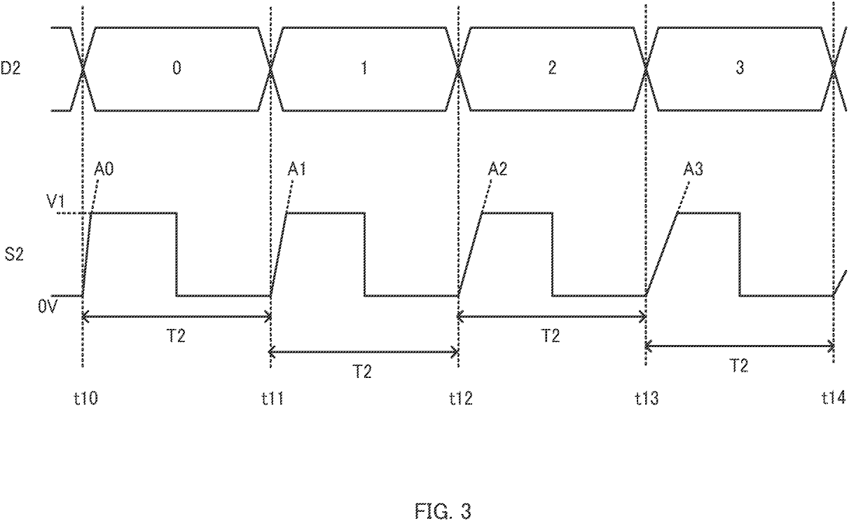

FIG. 3 is a diagram for explaining the signal S2 corresponding to the data D2 indicating any one of “0” to “3”. When the data D2 indicates “0”, the CPU 41 generates the signal S2 that goes high at a slope A0 and then goes low, as indicated from time t10 to time t11.

When the data D2 indicates “1”, the CPU 41 generates the signal S2 that goes high at a slope A1 and then goes low, as indicated from time t11 to time t12. In addition, when the data D2 indicates “2”, the CPU 41 generates the signal S2 that goes high at a slope A2 and then goes low, as indicated from time t12 to time t13.

Moreover, when the data D2 indicates “3”, the CPU 41 generates the signal S2 that goes high at a slope A3 and then goes low, as indicated from time t13 to time t14. Note that a time period of the signal S2 corresponding to the minimum unit (in this case, any one value of 0 to 3) of the information included in the data D2 is a time period T2. In an embodiment of the present disclosure, each of the slopes A0 to A3 has a positive value and satisfies a relationship of A0 > A1 > A2 > A3.

In addition, in an embodiment of the present disclosure, the CPU 41 generates the signals S1 and S2 such that the time period T1 of the signal S1 and the time period T2 of the signal S2 are equal to each other. Thus, for example, the waveform of the signal S1 indicating “1” and the waveform of the signal S2 indicating “0” to “3” are similar to each other although the slopes at which the signals go high are different from each other.

Accordingly, even in a case where a voltage at the wiring 22 is watched from the outside when the signal S1, S2 is transmitted to the microcomputer 21, it is difficult to identify that the signals S1 and S2 are different signals. With such signals S1 and S2 being transmitted and received between the microcomputers 20 and 21, the data D1 and D2 can be safely communicated similarly to the case of encryption, which will be described later.

Note that the signal S1 corresponds to a “first signal”, and the signal S2 corresponds to a “second signal”. In addition, the low level of the signals S1 and S2 corresponds to a “first level”, and the high level thereof corresponds to a “second level”. Moreover, the data D1 corresponds to “first data”, and the data D2 corresponds to “second data”.

### Microcomputer 21

The microcomputer 21 is a “receiver circuit” that receives the data D1, D2 in response to the signal S1, S2 transmitted from the microcomputer 20, and includes an analog-to-digital converter (ADC) 50, a memory 51, and a CPU 52.

The ADC 50 obtains analog signal S1, S2 received through the wiring 22, and converts it into a digital value. Note that the AD converter 50 obtains the signal S1, S2 with a sufficiently short sampling cycle so that the CPU 52, which will be described later, can determine a value of a rising slope of the signal S1, S2.

Similarly to the memory 40, the memory 51 is a circuit to store various data and/or a program to be executed by the CPU 52.

The CPU 52 is a processor that executes the program stored in the memory 51, to thereby control over the entirety of the microcomputer 21. In an embodiment of the present disclosure, with the CPU 52 executing the program, a determination unit 60 and an acquisition unit 61 are implemented in the CPU 52. Note that the CPU 52 corresponds to a “processing circuit”.

Based on a digital value received from the AD converter 50, the determination unit 60 determines whether the signal (hereinafter, referred to as an input signal Sin) received through the wiring 22 is the signal S1 or S2. When a rising slope of the input signal Sin satisfies a predetermined condition (hereinafter, referred to as a condition X), the determination unit 60 determines that the input signal Sin is the signal S1, and when the rising slope does not satisfy the condition X, the determination unit 60 determines that the input signal Sin is the signal S2.

The “condition X” herein is that the rising slope of the input signal Sin is sufficiently greater than the slope A0 or that the rising slope of the input signal Sin is sufficiently smaller than the slope A3. Note that when the input signal Sin is the signal S1 indicating “1”, the rising slope of the input signal Sin is sufficiently greater than the slope A0, and when the input signal Sin is the signal S1 indicating “0”, the rising slope of the input signal Sin is sufficiently smaller than the slope A3.

Note that, for example, upon obtaining a predetermined signal (so-called start bit) previously transmitted before the signal S1, S2 from the microcomputer 20, the determination unit 60 of an embodiment of the present disclosure executes the above-described processing of determining the input signal Sin.

When it is determined that the input signal Sin is the signal S1, the acquisition unit 61 acquires the data D1 (i.e., a value of “0”, “1”) based on a logic level of the signal S1. In addition, when it is determined that the input signal Sin is the signal S2, the acquisition unit 61 acquires the data D2 (i.e., a value of “0” to “3”) based on the rising slope of the signal S2.

### Transmission and Reception of Data D1 and D2

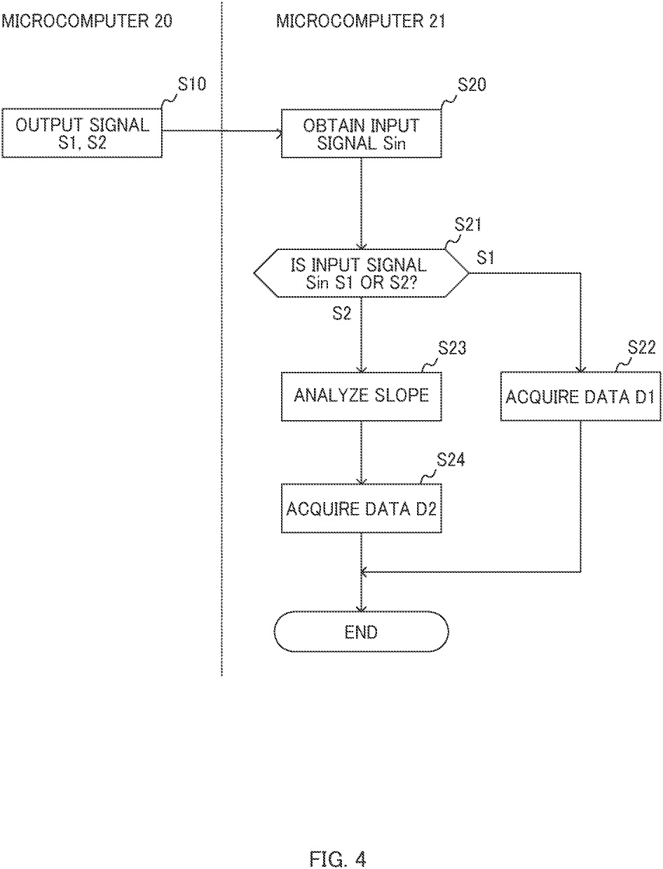

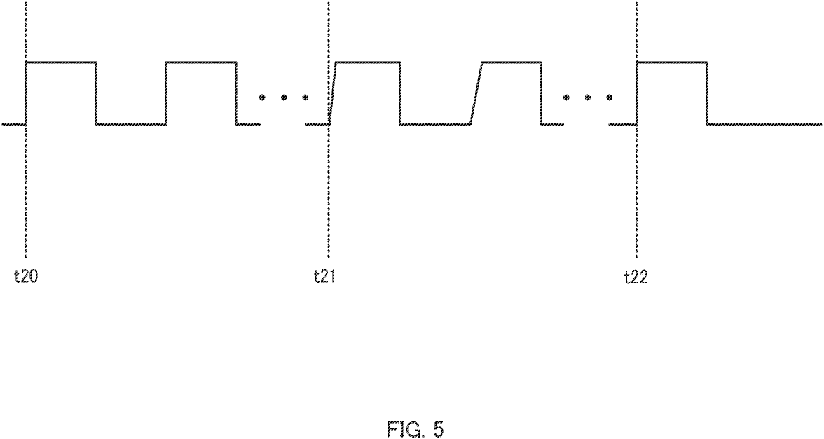

FIG. 4 is a flowchart illustrating an example of processing of transmitting and receiving data by the microcomputers 20 and 21. FIG. 5 is a diagram illustrating an example of the signals S1 and S2 outputted from the microcomputer 20.

First, as illustrated in FIG. 4, the microcomputer 20 outputs the signal S1, S2 corresponding to the data D1, D2, according to a predetermined protocol (S10). Specifically, for example as illustrated in FIG. 5, the microcomputer 20 outputs the signal S1 from time t20 and outputs the signal S2 from time t21. In addition, the microcomputer 20 outputs the signal S1 from time t22.

The AD converter 50 of the microcomputer 21 obtains the input signal Sin received through the wiring 22 (S20). The determination unit 60 then determines whether the input signal Sin is the signal S1 or the signal S2 (S21). When the input signal Sin is the signal S1 (S21: S1), the acquisition unit 61 acquires the data D1, based on the logic level of the signal S1 (S22).

On the other hand, when the input signal Sin is the signal S2 (S21: S2), the acquisition unit 61 analyzes the rising slope of the signal S2 (S23). Specifically, the acquisition unit 61 calculates the rising slope of the signal S2, to thereby determine which of the slopes A0 to A3 is the rising slope of the signal S2.

The acquisition unit 61 then acquires the data D2, based on the result of analysis of the rising slope of the signal S2 (S24).

As such, in an embodiment of the present disclosure, it is possible to communicate the data D2 different from the data D1 corresponding to the signal S1 by using the signal S2 with a waveform similar to that of the signal S1. Accordingly, even if the voltage at the wiring 22 is watched from the outside, the data D2 can be communicated without being grasped from the outside.

### Other Embodiments

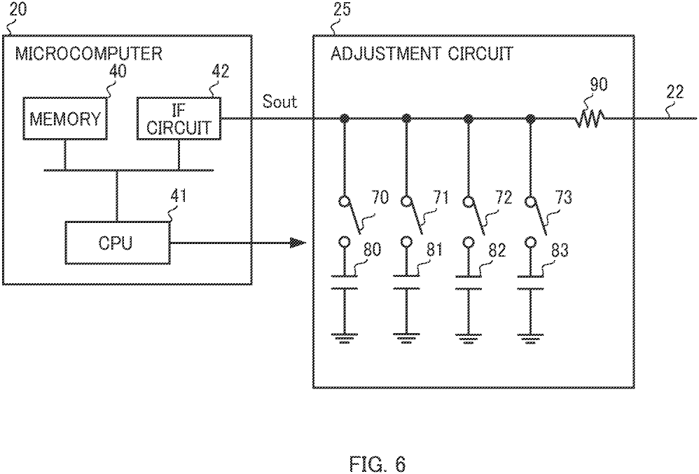

In the microcomputer 20 in FIG. 1, the CPU 41 generates the signals S1 and S2; however, it is not limited thereto. For example, the microcomputer 20 may control an external adjustment circuit 25, to thereby generate the signals S1 and S2. Note that, blocks with the same reference numerals are the same between FIGS. 1 and 6, and thus here a signal Sout outputted from the microcomputer 20 and the adjustment circuit 25 will be mainly described.

Based on the data D1 indicating “1” and the data D2 indicating “0” to “3”, the microcomputer 20 generates the signal Sout of a rectangular waveform, that is, a signal having the same waveform as that of the signal S1 from time t0 to time t1 in FIG. 2. In addition, based on the data D1 indicating “0”, the microcomputer 20 generates the low signal Sout, that is, a signal having the same waveform as that of the signal S1 from time t1 to time t2 in FIG. 2.

The adjustment circuit 25 adjusts the rising slope of the signal Sout outputted from the IF circuit 42, and includes switches 70 to 73, capacitors 80 to 83, and a resistor 90.

The switches 70 to 73 are elements that are controlled to be on and off by the CPU 41. The switches 70 to 73 are coupled with the capacitors 80 to 83, respectively. In addition, the resistor 90 is coupled in series with the wiring 22. Note that, in an embodiment of the present disclosure, the capacitance values of the capacitors 80 to 83 are the same.

When transmitting the data D1 indicating “1”, the CPU 41 turns off all the switches 70 to 73. Then, the waveform of the signal Sout results in the waveform of the signal S1 corresponding to the data D1 indicating “1” (from time t0 to time t1 in FIG. 2).

When transmitting the data D2 indicating “0”, the CPU 41 turns on the switch 70 and turns off the switches 71 to 73. Then, the waveform of the signal Sout results in the waveform of the signal S2 having the rising slope A0 (from time t10 to time t11 in FIG. 3).

When transmitting the data D2 indicating “1”, the CPU 41 turns on the switches 70 and 71 and turns off the switches 72 and 73. Then, the waveform of the signal Sout results in the waveform of the signal S2 having the rising slope A1 (from time t11 to time t12 in FIG. 3).

When transmitting the data D2 indicating “2”, the CPU 41 turns on the switches 70 to 72 and turns off the switch 73. Then, the waveform of the signal Sout results in the waveform of the signal S2 having the rising slope A2 (from time t12 to time t13 in FIG. 3).

When transmitting the data D2 indicating “3”, the CPU 41 turns on all the switches 70 to 73. Then, the waveform of the signal Sout results in the waveform of the signal S2 having the rising slope A3 (from time t13 to time t14 in FIG. 3).

Note that, when transmitting the data D1 indicating “0”, the CPU 41, for example, turns off all the switches 70 to 73 and outputs the low signal Sout. As such, even in a case of using the microcomputer 20 and the adjustment circuit 25, desired signals S1 and S2 can be outputted.

### Others

In an embodiment of the present disclosure, the slopes of the signal S2 correspond to “0” to “3” that are values of the data D2, respectively; however, it is not limited thereto. For example, when the values of the data D2 are only two values of “0” and “1”, the slopes of the signal S2 may be A0 and A1. In addition, the slope of the signal S2 may be changed in four or more variations according to the values of the data D2.

In addition, in an embodiment of the present disclosure, the rising slope of the signal S2 is changed according to the data D2; however, for example, a falling slope of the signal S2 or both the rising and falling slopes of the signal S2 may be changed.

### Summary

The microcomputer 20 of an embodiment of the present disclosure has been described above. The microcomputer 20 transmits the signal S1, S2 corresponding to the data D1, D2 to the microcomputer 21. As a result, the microcomputer 20 can safely transmit the data D2 different from the data D1 without complicated processing such as encryption.

In addition, the microcomputer 21 determines whether the input signal Sin is the signal S1 or S2, to thereby acquire the data D1, D2 according to the result of the determination. Accordingly, the microcomputer 21 of an embodiment of the present disclosure determines the data D1, D2, based on the slope of the signal S1, S2, and thus it is possible to safely receive the data D2 different from the data D1 without complicated processing such as encryption.

Moreover, with the use of the communication circuit 10 including the microcomputers 20 and 21, the data D2 different from the data D1 can be safely received without complicated processing.

Furthermore, the microcomputer 20 may, for example, change both the rising slope and falling slope of the signal S2, based on the data D2. However, in an embodiment of the present disclosure, only the rising slope of the signal S2 is changed, thereby being able to reduce an amount of processing by the microcomputer 20.

In addition, the microcomputer 20 causes each of the signals S1 and S2 to change between 0V and the level of the voltage V1. That is, the low level and the high level of the signal S1 and the low level and the high level of the signal S2 coincide with each other. Accordingly, in an embodiment of the present disclosure, the waveforms of the two signals S1 and S2 can be similar to each other, and thus the data D2 can be transmitted more safely.

The present disclosure is directed to provision of a transmitter circuit, a receiver circuit, and a communication circuit capable of safely communicating data without complicated processing.

It is possible to provide a transmitter circuit, a receiver circuit, and a communication circuit capable of safely communicating data without complicated processing.

The above embodiments are intended to facilitate understanding of the present disclosure and not intended for limited interpretation of the present disclosure. In addition, it is needless to say that the present disclosure can be changed or modified without departing from the intent, and the present disclosure includes an equivalent thereof.

What is claimed is:

1. A transmitter circuit coupled to a receiver circuit through wiring, the receiver circuit including
an analog-to-digital (AD) converter configured to receive an input signal through the wiring, and
a processing circuit configured to process an output of the AD converter,
the transmitter circuit comprising:
a circuit configured to transmit to the AD converter of the receiver circuit, as the input signal, either
a first signal of a rectangular waveform having a logic level that changes according to first data, or
a second signal of a waveform having a slope that changes corresponding to second data,
such that the processing circuit
processes the output of the AD converter to thereby determine whether the input signal is the first signal or the second signal,
when it is determined that the input signal is the first signal, acquires the first data, based on the logic level of the first signal, and
when it is determined that the input signal is the second signal, acquires the second data, based on the slope of the second signal.

2. A receiver circuit coupled, through wiring, to a transmitter circuit, the transmitter circuit being configured to transmit, as an input signal, either
a first signal of a rectangular waveform having a logic level that changes according to first data, or
a second signal of a waveform having a slope that changes corresponding to second data,
the receiver circuit comprising:
an analog-to-digital (AD) converter configured to receive the input signal through the wiring; and
a processing circuit configured to
process an output of the AD converter to thereby determine whether the input signal is the first signal or the second signal,
when it is determined that the input signal is the first signal, acquire the first data, based on the logic level of the first signal, and
when it is determined that the input signal is the second signal, acquire the second data, based on the slope of the second signal.

3. A communication circuit, comprising:
a transmitter circuit; and
a receiver circuit coupled to the transmitter circuit through wiring, wherein
the transmitter circuit is configured to transmit to the receiver circuit through the wiring, as an input signal, either
a first signal of a rectangular waveform having a logic level that changes according to first data, and
a second signal of a waveform having a slope that changes corresponding to second data,
the receiver circuit includes
an analog-to-digital (AD) converter configured to receive the input signal through the wiring, and
a processing circuit configured to
process an output of the AD converter to thereby determine whether the input signal is the first signal or the second signal,
when it is determined that the input signal is the first signal, acquire the first data, based on the logic level of the first signal, and
when it is determined that the input signal is the second signal, acquire the second data, based on the slope of the second signal.

4. The communication circuit according to claim 3, wherein
the slope is either a rising slope or a falling slope of the second signal.

5. The communication circuit according to claim 3, wherein
each of the first and second signals changes between a first level and a second level.
